(19) United States
(12) Patent Application Publication
(10) Pub. No.: US 2016/0223382 A1
(43) Pub. Date: Aug. 4, 2016

(54) SENSOR DEVICE

(71) Applicant: PEPPERL + FUCHS GMBH, Mannheim (DE)

(72) Inventor: Ernst LUBER, Neukirchen (DE)

(73) Assignee: PEPPERL + FUCHS GMBH, Mannheim (DE)

(21) Appl. No.: 14/906,020

(22) PCT Filed: Jul. 17, 2014
(86) PCT No.: PCT/EP2014/065404

§ 371 Date: Mar. 3, 2016

(30) Foreign Application Priority Data
Jul. 19, 2013 (DE) 102013107707.2

(51) Int. Cl. G01F 23/296

(52) U.S. Cl. CPC G01F 23/2962

(57) ABSTRACT

A sensor device for detecting the fill level in a collection container includes an ultrasound transducer and is designed such that the sensor device, and thus the ultrasound transducer, can switch between an active operating mode and a power-saving mode. The sensor device and the ultrasound transducer arranged therein require less energy in the power-saving mode than in the operating mode. In the power-saving mode, the sensor device can be brought into the active operating mode using environmental signals and external trigger conditions, which can be configured specifically for a given collection container type. An activation device is provided, which is designed such that, based on an external signal, the activation device causes the sensor device to switch into the active operating mode, wherein the ultrasound transducer performs at least one measurement in the active operating mode. The sensor device has a low-power interface for wireless transfer of data.

The invention relates to a sensor device according to the preamble of claim 1 and to a method according to the characteristics of claim 11.

A sensor device contains a sensor, with which specific physical, chemical, properties or also a material composition of an environment can be detected. Such a sensor device can be used in the form of an autarchic system. In these autarchic systems, the main problem consists of an energy supply over an extended period of time. In order to achieve the longest possible useful lifetime of this autarchic system, intelligent power management is required, with which the consumption of electricity is reduced.

Such an autarchic system is known from DE 10 200 038 756 A1. This autarchic system possesses a sensor system that is structured in such a manner that it can switch between an active operating state and an idle operating state, wherein the sensor system requires less energy in the idle operating state than in the active operating state. Furthermore, the autarchic system comprises a wake-up device, which is structured in such a manner that in response to a wake-up signal that reaches the autarchic system, it causes the sensor system to switch to the active operating state, wherein the wake-up signal is an acoustical and/or optical signal.

A further system for measurement of a fill level by means of an ultrasound sensor is described in US 2007/261487 A1.

It is therefore the task of the present invention to make available a sensor system that is in a power-saving mode when it is not in an active operating state, wherein the switch to the active operating state is supposed to take place by means of an external sensor signal.

This task is accomplished in accordance with the characteristics of claim 1 as well as in accordance with the characteristics of claim 11.

The invention relates to a sensor device for detecting the fill level of a collection container, wherein the sensor device is preferably configured as an ultrasound sensor. The sensor device is structured in such a manner that the sensor device can switch between an active operating state and a power-saving mode, wherein the sensor device requires less energy in the power-saving mode than in the active operating state. For this purpose, the sensor device has an activation device, which is structured in such a manner that the activation device causes an ultrasound transducer to switch to an active operating state in response to an external signal that reaches the activation device, wherein the ultrasound transducer carries out at least one fill level measurement in the operating state.

Before the measurements, the sensor device has been configured with regard to defined general conditions for a specific collection container type, wherein the sensor device has a control input that is structured in such a manner that in the power-saving mode, signals that come from the activation device can be detected by the control input. Configuration takes place as a function of the trigger conditions required for the measurement (for example as a function of the temperature or relative humidity). In addition, a reference variable for the fill level is determined for the sensor device, for a specific collection container type. Thereby the required general conditions are defined by means of establishing the trigger conditions and the limit values for the fill level for a specific collection container type.

Because the sensor device has been configured for a specific collection container type, i.e. for a specific application, before the measurements, with regard to specific general conditions, the sensor device and thereby the ultrasound transducer cannot be switched to the active operating state without having been previously addressed by the activation device, thereby preventing the ultrasound transducer from carrying out unnecessary measurements.

If the sensor device and thereby the ultrasound transducer is in the power-saving mode, a transmission/reception unit is deactivated, and all the trigger inputs, such as, for example, the control input disposed in the sensor device, are activated. It is advantageous that the sensor device, when it is in power-saving mode, can be brought into the active operating state in targeted manner, by means of the detection of environmental signals.

It is advantageous if the sensor device is supplied with energy by means of an energy generation device for energy harvesting, with which device it is possible to obtain energy from the environment. In order for the energy that has been generated to be stored, as well, when the sensor device does not require the energy, the sensor device possesses a storage system with which the energy obtained from the environment can be stored.

In order to make it possible to switch the sensor device into the active operating state at defined intervals, the activation device can have a time-recording system. This time-recording system can be a radio clock.

If, in contrast, the sensor device is supposed to be switched into the active operating state by means of external influences, then the activation device can have a light sensor, an electrical contact, a movement sensor, a temperature sensor or a vibration measurement device.

It is advantageous if the sensor device has a voltage regulator having a voltage monitoring unit. In this way, it is possible to check, at any point in time, whether sufficient energy is present to keep the ultrasound sensor in power-saving mode. In this way, it is guaranteed that the sensor device is always supplied with sufficient power, wherein this information is transmitted to an higher-level controller, using a local reporting apparatus or a remote-control module. For example, a disposal company can be informed about the fill level of the collection container or about the operational readiness of the ultrasound sensor, by way of the higher-level controller, if it is a remote-control module (GSM, WLAN). In this way, the sensor device is prevented from switching off if insufficient energy is available for the active operating mode. In this regard, the operational readiness of the sensor device can be monitored cyclically by means of a watchdog or a real-time clock, i.e. at defined time intervals. In this regard, it is also possible that the higher-level controller is an integral part of the sensor device.

The sensor device comprises a control unit that is connected with the control input, wherein, the control unit is brought into the active operating state after the control input has received a signal from the activation device.

If the sensor device is supposed to be switched to the active operating state by means of external influences, then an external serial bus can be provided, which stands in contact with the activation device. In this regard, the activation device comprises a sensor, with which the external influences can be detected. This sensor can be, for example, a light sensor, a vibration measurement device, an electrical contact, an acceleration sensor or a temperature sensor.

It is advantageous if the ultrasound sensor has a low-energy interface for wireless data transmission. The measurement data detected can be transmitted to an higher-level controller by way of the low-energy interface, together with an energy status of the sensor device that has been determined. In this regard, the controller comprises a display, by way of which the measurement data detected can be displayed to a user. The energy status can also be displayed by the display, thereby informing a user at any point in time how much energy the sensor device is using in power-saving mode or, alternatively, in the operating state.

In order for no measurement data to be lost when the ultrasound sensor switches from the operating state into power-saving mode, it is possible to provide a non-volatile data memory in which the detected measurement data can be stored. For example, a FRAM (Ferroelectric Random Access Memory) can be used as a non-volatile data memory. This data memory is an energy-optimized and speed-optimized memory module, which does not require a charging pump, because this data memory possesses crystals having ferroelectric properties.

It is advantageous if the control unit of the sensor device is connected with the ultrasound transducer, wherein the ultrasound transducer can be switched to the active operating state by way of the control unit.

The invention also relates to a method for switching a sensor device that is in the idle state to an active operating state, wherein the sensor device carries out multiple measurements in the active operating state, containing the following steps:
a) an activation device is addressed by at least one external environmental signal;
b) the activation device transmits a signal to a control input of the sensor device;
c) a control unit is activated in the sensor device;
d) the control unit addresses an ultrasound transducer that emits an ultrasound signal for a specific detection region, which signal is reflected in the interior of a collection container, wherein the reflected signal is received back by the ultrasound transducer;
e) the signal is converted to an electrical signal in the ultrasound transducer, and passed on to the control unit;
f) a distance value for the detection region is determined from the electrical signal in the control unit;
g) the distance value determined is transmitted to an higher-level controller;
h) steps d) to g) are repeated for every detection region to be measured;
i) the higher-level controller calculates the fill level of the collection container for the different detection regions, from the distance values determined.

An exemplary embodiment will be explained and described in greater detail below, using figures. These show:

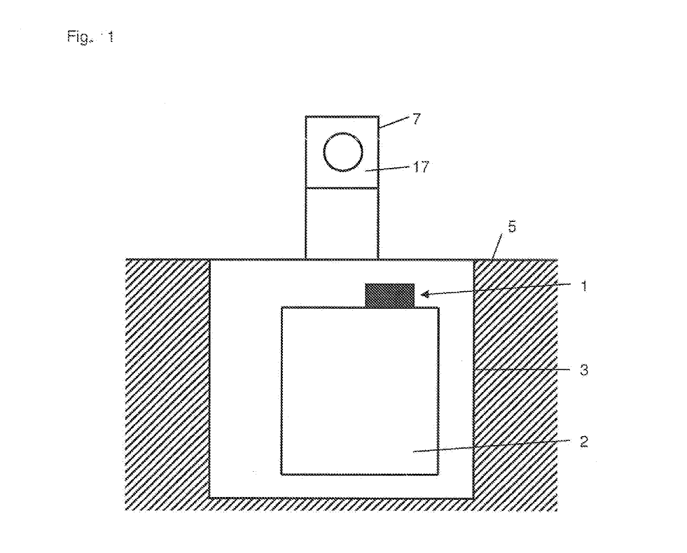

FIG. 1 a sensor device for detecting the fill level of a collection container, and

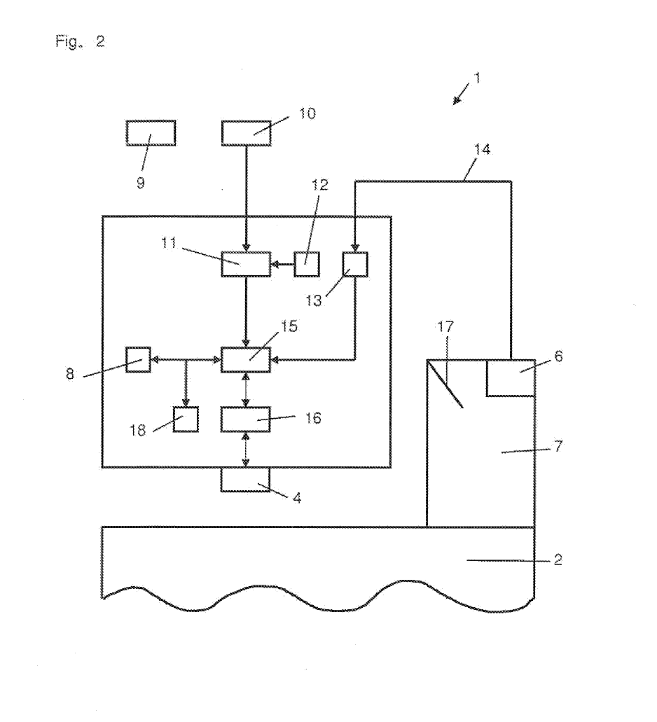

FIG. 2 a schematic structure of the sensor device shown in FIG. 1.

In FIG. 1, a sensor device 1 for detecting the fill level of a collection container 2 is shown. This collection container 2—as shown in FIG. 1—can be an underfloor container 2. This underfloor container 2 is housed in a chamber 3, which can be part of a building (not shown). The chamber 3, in which the underfloor container 2 is housed, lies underneath a bottom 5. A filling shaft 7 having a filling cover 17 can be seen above the bottom 5.

It is possible to charge the underfloor container 2 by way of the filling shaft 7. If the underfloor container 2 is a waste container, for example, this underfloor container can be charged with waste by way of the filling shaft 7.

The fill level of the underfloor container 2 can be measured using the sensor device 1, wherein the sensor device 1 is configured as an ultrasound sensor in this exemplary embodiment. For this purpose, the sensor device 1 is configured in such a manner that it can switch between an active operating state and a power-saving mode. If the filling cover 17 of the filling shaft 7 is closed, the sensor device 1 is in the power-saving mode. In this power-saving mode, the sensor device 1 uses less energy than in the active operating state. If, however, the filling cover 17 is opened, the sensor device 1 starts to measure the fill level of the underfloor container 2. During this method for detecting the fill level in the underfloor container 2, an ultrasound transducer (not shown in FIG. 1) disposed in the sensor device 1 transmits signals that are reflected by the contents or by the bottom of the underfloor container 2. These echo signals are processed in the sensor device 1, so that the fill level in the underfloor container 2 can be determined. Because such a method for detecting a fill level is known as such, and is disclosed in EP 2 148 219 B1, for example, no detailed description of this method will be given. However, in order for the sensor device 1 to be able to carry out the measurements, it must be switched to the active operating state. For this purpose, an activation device (not shown) is provided, which—depending on external influences, for example—switches the sensor device 1 and thereby also the ultrasound transducer to the active operating state. For this purpose, the activation device has, for example, a light sensor, a movement sensor, a temperature sensor, an electrical contact or a vibration measurement device.

It is advantageous if the activation device is affixed to the filling cover 17 of the filling shaft 7 or in the filling shaft 7. When the filling cover 17 is opened, the electrical contact is interrupted; this is registered by the activation device, and as a result, it transmits a signal to the sensor device 1; this causes the sensor device 1 to switch to the active operating state. When the filling cover 17 is closed again, the electrical contact is restored; this is registered by the activation device, and the sensor device 1 and thereby also the ultrasound transducer are caused to return to power-saving mode.

Therefore activation of the sensor device 1 takes place by way of a triggering apparatus that stands in connection with the activation device. This triggering apparatus—as described in the present exemplary embodiment—can be the filling cover 17, with which an electrical contact is closed or a vibration measurement device or a light sensor is excited. During startup, the sensor device 1 can be configured with the most varied trigger conditions.

If the activation device has a vibration measurement device as well as a light sensor, for example, this activation device then sends a signal to the sensor device 1 when the activation device has been excited by light and/or by a vibration. Therefore a switch from power-saving mode to the active operating mode takes place by means of an AND/OR operation of two signals, wherein these two signals are light and vibration.

Although this is not shown in FIG. 1, a display can advantageously be provided on the chamber 3 or on the filling shaft 7, by way of which it can be displayed whether the underfloor container 2 is full and whether it must be emptied. As a result, it can be recognized whether or not the under floor container 2 needs to be emptied, even outside of the chamber 3 and without opening the underfloor container 2.

Specifically in the case of underfloor containers, in other words in the case of very large collection containers, such a advantageous, because these large collection containers can only be moved and emptied with very great effort, for example by means of a mobile crane.

In FIG. 2, a schematic structure of the sensor device 1 shown in FIG. 1 is shown.

In order for the sensor device 1 to be able to switch between an active operating state and a power-saving mode, this sensor device 1 has a control unit 15 and a transmission/reception unit 16, wherein the control unit 15 and the transmission/reception unit 16 also require less energy in power-saving mode than in the active operating state. In order for the sensor device 1 to be able to continue to receive signals in this power-saving mode, the sensor device 1 has a control input 13. In this regard, the control input 13 receives signals of the activation device 6, which are transmitted to the control input 13 by the activation device 6 after the activation device 6 was addressed by external environmental signals (for example by means of light, vibrations, triggering of an electrical contact). After the control input 13 has received a signal from the activation device 6, the control input 13 addresses the control unit 15 in targeted manner. As a result, the control unit 15 is switched to the active operating state. If the control unit 15 is in the active operating state, the ultrasound transducer 4 of the is caused to carry out at least one measurement, by the control unit 15. In this regard, the sensor device 1 has been configured for a specific collection container type, i.e. for a specific application, before the measurements, with regard to specific general conditions.

It is understood that the temperature, the light intensity or the relative humidity can also be measured with the sensor device 1, if the sensor device 1 is equipped with a corresponding sensor.

The activation device 6 is disposed in the filling shaft 7, wherein the underfloor container 2 can be charged with material (not shown), for example waste, by way of this filling shaft 7. For this purpose, the filling shaft 7 has the filling cover 17, which roust be opened ahead of time, if the underfloor container 2 is supposed to be filled with material.

This activation device 6 is structured in such a manner that, the activation device 6 causes the sensor device 1 and thereby also the ultrasound transducer 4 to switch to the active operating state on the basis of an external signal, wherein the ultrasound transducer 4 carries out at least one measurement in the active operating state. Activation of the activation device 6 takes place by way of a triggering apparatus that stands in connection with the activation device 6. In FIG. 2, this triggering apparatus is the filling cover 17, with which an electrical contact is closed, a light sensor or a vibration measurement device is excited. The sensor device 1 can be configured with different external trigger conditions at startup. Thus, for example, a switch from power-saving mode to the active operating mode can take place by means of an AND/OR operation of two device as well as a light sensor, for example, this activation device 6 then transmits a signal to the sensor device 1 when the activation device 6 has been excited by light and/or by a vibration. Therefore a switch from power-saving mode to the active operating mode takes place, in the sensor device 1, by means of the AND/OR operation of two signals, wherein these two signals are light and vibration.

As has already been explained, the sensor device 1 is configured in application-specific manner before startup, in order to guarantee that the ultrasound transducer 4 of the sensor device 1 does not get into the active operating state and thereby carry out measurements unnecessarily, without having been switched to the active operating state by the activation device 6. This configuration takes place as a function of the required trigger conditions (for example as a function of temperature or relative humidity) for the measurement. In addition, in this regard a reference variable for the fill level is determined for the sensor device 1. For this purpose, the limit values for the fill level are determined during startup of the sensor device 1, wherein the minimal fill level (=collection container is empty) is input as the lower limit value, and the maximal fill level (=collection container is full) is input as the upper limit value. Thereby, general conditions are defined for the fill level for a specific collection container type, on the basis of which conditions the sensor device 1 is configured, by means of establishing trigger conditions as well as limit values for the fill level.

An higher-level controller 3 can be recognized, to which the measurement data determined and evaluated by the sensor device 1 are transmitted. The higher-level controller 9 can have an evaluation unit, with which the transmitted measurement data can be evaluated further. In order to make it possible for the measurement data to be displayed to a user, a display, not shown, for example a monitor, can be connected with the higher-level controller 9.

A low-energy interface 8 for data transmission, disposed in the sensor device 1, can also be recognized. By means of this low-energy interface 8 for data transmission, the measurement data recorded by means of the measurement are transmitted to the higher-level controller 9 without any time delay. The low-power interface 8 can be a serial low-power interface 8, if the higher-level controller 9 is connected with the sensor device 1 by way of a hard-wired network. If the signal is transmitted to the higher-level controller 9 by way of GMS or WLAN, for example, the low-power interface 8 can be a GMS module or a WLAN module. Measurement values previously evaluated in the control unit 15 are transmitted to the higher-level controller 9, using the low-power interface 8.

It is advantageous in this arrangement consisting of higher-level controller 9 and low-energy interface 8 that it is possible to forgo a buffer memory, in which the data have to be buffered. In this way, the apparatus effort is minimized.

It is understood that the higher-level controller 9 can also be part of the sensor device 1, but this is not the case in this exemplary embodiment.

An energy generation device 10 for energy harvesting is provided on the sensor device 1, with which energy, for example light or heat, is obtained from the environment. The energy generated with the energy generation device 10 is made available to a voltage regulator 11 having an integrated voltage monitoring unit. Using the voltage monitoring unit, it can be monitored at any point in time whether sufficient energy is present to keep the sensor device 1 in power-saving mode.

In order for the generated energy to be stored when the sensor device 1 does not require the energy obtained by means of the energy generation device 10, the sensor device 1 possesses a storage system 12, with which energy obtained from the environment can be stored. In this regard, this storage system 12 can be a thin-film energy storage device, which is characterized by great energy density. Because generation of energy by means of “energy harvesting” is known, this energy generation system will not be explained in detail.

Switching the sensor device 1 into the active operating state takes place by way of the activation device 6. The activation device 6 has an external sensor, not shown. This external sensor can be, for example, a light sensor, a movement sensor, an electrical contact or a vibration measurement device. Such sensors are known, and therefore the structure as well as the method of functioning of these sensors will not be discussed further.

The activation device 6 is connected with a control input 13 for the measurements, disposed in the sensor device 1, by way of a serial interface (see arrow 14). This control input 13 stands in connection with a control unit 15. Preferably, this control unit 15 is configured as a microcontroller. The control unit 15 also comprises a time-recording module as well as an energy-saving modem. Using the time-recording system, the sensor device 1 and thereby also the ultrasound transducer 4 are switched to the active operating state, independent of external sensor signals, in a configurable time raster, for example in order to check the energy status at defined time intervals. The transmission/reception unit 16 is provided between the control unit 15 and the ultrasound transducer 4.

Aside from activation devices that switch the ultrasound transducer 4 to the active operating state on the basis of external influences, there are also activation devices that possess a time-recording system, by means of which the ultrasound transducer 4 can be switched to the active operating state at defined time intervals. In this case, however, the control unit 15 would not have to have a time-recording system. This time-recording systems, can be a radio clock, for example.

Activation devices that switch the ultrasound transducer 4 to the active operating state on the basis of external influences can be, for example, a light sensor, an electrical contact or a vibration measurement device. If the activation unit is a light sensor, then this light sensor activates the ultrasound transducer 4 as soon as light falls on the light sensor, while a vibration measurement device reacts to vibrations and activates the ultrasound sensor 4 as soon as the vibration measurement device is exposed to vibrations and has registered these.

The control unit 15 is connected with a voltage regulator 11. This voltage regulator 11 takes on the power management, i.e. the voltage regulator 11 monitors the energy generation device 10, regulates the input voltage to the operating voltage range, and controls charging of the energy storage device 12. The input voltage can be monitored using a voltage monitoring unit disposed in the voltage regulator 11, wherein the voltage monitoring unit emits a warning to an external display or a remote-control system, if necessary, in the event that the input voltage of the energy generation device 10 drops below a critical value in power-saving mode.

Therefore it can be checked at any point in time, using the voltage monitoring unit of the voltage regulator 11, whether sufficient energy is present to keep the sensor device 1 and thereby also the ultrasound transducer 4 in power-saving mode. In this way, it is guaranteed that the sensor device 1 and thereby also the ultrasound transducer 4 are always supplied with sufficient current. In this way, the sensor device 1 is prevented from shutting off in power-saving mode because it is no longer supplied with sufficient energy. In this regard, the operational readiness of the sensor device 1 can be monitored by means of a watchdog or cyclically, i.e. at defined time intervals, by means of a real-time clock.

In order to switch the sensor device 1 and thereby also the ultrasound transducer 4 to the active operating state, an external serial bus can be provided. Independent of external signals, the ultrasound transducer 4 can be put into the active operating state by way of this serial interface, for example if the remote-control module is connected with the sensor device 1 by way of the serial bus, a disposal company can query the fill level of the selected underfloor container 2, in targeted manner.

In order for no measurement data to be lost when the sensor device 1 switches from the active operating state to power-saving mode, it is advantageous to provide a non-volatile data memory 18, with which the detected measurement data can be stored in memory. A FRAM (Ferroelectric Random Access Memory), for example, can be used as a non-volatile data memory 18. This data memory 18 is an energy-optimized and speed-optimized memory module, which does not require a charging pump, because this data memory 18 possesses crystals having ferroelectric properties. Such data memories are known, and therefore no detailed description is provided.

In the following, switching the sensor device 1 and thereby also the ultrasound transducer 4 from power-saving mode to the active operating state will be described.

If the external, sensor integrated into the activation device 6 is addressed, the activation device 6 then activates the control unit 15 by way of the control input 13. The control unit 15 addresses the ultrasound transducer 4 by way of the transmission/reception unit 16, and the transducer performs the distance measurement in the underfloor container 2. The voltage regulator 11 regulates the energy for the measurement, wherein this voltage regulator receives the energy from the energy storage device 12 or from the energy generation device 10.

During the measurement, the ultrasound transducer 4 emits an ultrasound signal that is reflected in the interior of the underfloor container 2. The reflected signal is subsequently received by the ultrasound transducer 4 again. The distance from the ultrasound transducer 4 to the interior of the underfloor container 2 is determined from the time that the signal emitted by the ultrasound transducer 4 requires to get back to the ultrasound transducer 4 as an echo. The reflected ultrasound signal is converted to an electrical signal by the ultrasound transducer 4 and passed on to the transmission/reception unit 16. The transmission/reception unit 16 transmits the signal to the control unit 15, which is determined, a distance value from the signal. This measurement is carried out for each one of the detection regions to be measured, so that multiple distance values are obtained. The distance values determined by the control unit 15 are transmitted, by way of the low-energy interface 8, to the higher-level controller 9, where the distance values determined are processed further, and in which the fill level of the underfloor container 2 is finally determined.

In this regard, the distance values determined are preferably transmitted to the higher-level controller 9, together with the energy status of the sensor device 1. If a display (not shown) is connected with the higher-level controller 9, both the distance values or the fill level and the energy status of the sensor device 1 and thereby also of the ultrasound transducer 4 can be displayed to a user. In this way, by way or the display, a user can be informed, at any point in time, how much energy the sensor device 1 and thereby also the ultrasound transducer 4 is consuming in the operating state or in power-saving mode.

### REFERENCE SYMBOL LIST

1 sensor device
2 collection container
3 chamber
4 ultra sound transducer
5 bottom
6 activation device
7 filling shaft
8 low-energy interface
9 higher-level controller
10 energy generation, device
11 voltage regulator
12 storage system
13 control input
14 arrow
15 control unit
16 transmission/reception unit
17 filling cover
18 non-volatile memory

1. Sensor device (1) for detecting the fill level of a collection container (2), having
an ultrasound transducer (4),
an activation device (6), which is structured in such a manner that the activation device (6) causes the ultrasound transducer (4) to switch to an active operating state in response to an external signal that reaches the activation device (6), wherein the ultrasound transducer (4) carries out at least one measurement in the operating state,
wherein the sensor device (1) is configured in such a manner that before the measurements, the sensor device (1) can be configured with regard to defined general conditions for a specific collection container type, and wherein the sensor device (1) has a control input (13) that is structured in such a manner that signals that come from the activation device (6) can be detected by the control input (13), wherein the general conditions comprise trigger conditions as well as limit values for the fill level, and wherein the trigger signals relate to at least one environmental signal, and wherein the activation device (6) comprises a light sensor, a movement sensor, an electrical contact or a vibration measurement device.

2. Sensor device according to claim 1, wherein an energy generation device (10) for energy harvesting is provided, wherein the sensor device (1) comprises a storage system (12) with which the energy obtained by means of energy harvesting can be stored.

3. Sensor device according to claim 1, wherein the activation device (6) is a time-recording system, with which the ultrasound transducer can be switched to the active state at defined time intervals, wherein the time-recording system is a radio clock or a real-time clock.

4. Sensor device according to claim 1, wherein the control input (13) is connected with a control unit (15), wherein the control unit (15) can be brought into the active operating state after the control input (13) has received a signal from the activation device (6).

5. Sensor device according to claim 1, wherein the voltage regulator (11) has an energy monitoring unit, with which the energy present in the sensor device (1) during power-saving mode can be monitored.

6. Sensor device according to claim 1, wherein a watchdog is provided, with which the operational readiness of the ultrasound transducer (4) can be cyclically monitored.

7. Sensor device according to claim 1, wherein an external serial bus is provided, with which the ultrasound transducer (4) can be switched to the active operating state.

8. Sensor device according to claim 1, wherein the detected measurement data can be transmitted to an higher-level controller (9), together with the energy status of the ultrasound transducer (4), by means of a low-power interface (8).

9. Sensor device according to claim 1, wherein a non-volatile data memory (18) is provided, with which the detected measurement data can be stored when the ultrasound transducer (4) switches from the active operating state to power-saving mode.

10. Sensor device according to claim 4, wherein the control unit (15) is connected with the ultrasound transducer (4) by way of a transmission/reception unit (16), wherein the ultrasound transducer (4) can be switched to the active operating state by way of the control unit (15).

11. Method for switching a sensor device (1) that is in the idle state to an active operating state, wherein the sensor device (1) carries out multiple measurements in the active operating state, containing the following steps:
a) an activation device (6) configured as a light sensor, an electrical contact or a vibration measurement device is addressed by at least one external environmental signal, in accordance with a trigger condition for a specific collection container type;
b) the activation device (6) transmits a signal to a control input (13) of the sensor device (1);
c) a control unit (15) is activated in the sensor device (1);
d) the control unit (15) addresses an ultrasound transducer (4) that emits an ultrasound signal for a specific detection region, which signal is reflected in the interior of a collection container (2), wherein the reflected signal is received back by the ultrasound transducer (4);
e) the signal is converted to an electrical signal in the ultrasound transducer (4), and passed on to the control unit (15);
f) a distance value for the detection region is determined from the electrical signal in the control unit (15);
g) the distance value determined is transmitted to a higher-level controller (9);
h) steps d) to g) are repeated for every one of the detection regions to be measured;
i) the higher-level controller (9) calculates the fill level of the collection container (2) for the different detection regions from the distance values determined.
